(19) United States
(12) Patent Application Publication
(10) Pub. No.: US 2025/0339735 A1
(43) Pub. Date: Nov. 6, 2025

(54) SYSTEM AND METHOD FOR GOLF COURSE MANAGEMENT

(71) Applicants: Angie Woodward, Powell, WY (US); Dalton Woodward, Powell, WY (US)

(72) Inventors: Angie Woodward, Powell, WY (US); Dalton Woodward, Powell, WY (US)

(21) Appl. No.: 19/013,779

(22) Filed: Jan. 8, 2025

Related U.S. Application Data
(60) Provisional application No. 63/642,284, filed on May 3, 2024.

(51) Int. Cl. A63B 24/00; A63B 71/06

(52) U.S. Cl. CPC A63B 24/0021; A63B 71/06; A63B 2024/0025; A63B 2024/0028

(57) ABSTRACT

A system that makes it easier for golfers to connect with other golfers using geolocation features based on similar interests and playing styles. The system helps the golfer to book available tee times at a golf course of their choosing in their geolocation. The system can score the games, calculate handicaps, play the golf course with GPS mapping, and find and locate the balls faster. The system also allows golfers to improve their game with Al technology and Game Coaching features. The system also connects clubhouses with golfers so that they can order food and beverages while playing and enjoy the same directly after finishing the game.

### CROSS-REFERENCE TO RELATED APPLICATIONS

This application claims priority from a U.S. Provisional Patent Appl. No. 63/642,284, filed on May 3, 2024, which is incorporated herein by reference in its entirety.

### FIELD OF INVENTION

The present invention relates to a system and method for managing various activities at a sports place, and more particularly, the present invention relates to a system and method for managing various activities at a golf course.

### BACKGROUND

Golf is a fun game that many people enjoy playing. But it can also be frustrating to manage all the particulars—tee time, payment, scoring and handicap differentials, tournament play, golf cart rental, finding someone to play with, food and beverages—that are all necessary to enjoy time on the golf course.

All such activities make a golfer very tired and often frustrated. Also, a golfer may not be able to take desired services. Also, there is often a shortage of labor at golf courses. Thus, the overall experience of the golfers at the golf courses is mostly unsatisfactory despite the availability of most of the services.

A need is there for a system and method that allows managing various activities at a golf course.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can connect golfers with other golfers, and the golfers to the clubhouses, and manage various activities, such as tee times, tournament play, and game scoring for the members.

Another object of the present invention is that golf course-related activities can be managed at an individual level.

Still, another object of the present invention is that the golfer can focus on his game.

Yet another object of the present invention is that a golfer can easily find other golfers to play with.

A further object of the present invention is that starting a new golf club or operating an existing one can be made easier.

Still, a further object of the present invention is to assist golfers in pairing with other golfers in a specific geolocation by seeing available golf courses and golfers in their geolocation.

In one aspect, disclosed is a system that may make it easier for golf clubs to manage the golf course's tee-time bookings, manage memberships, manage tournament play, send push notifications to their members for clubhouse news and upcoming events, and manage payments for tee-time bookings, tournaments, pro-shop purchases, and food and beverages orders and purchases.

In one aspect, disclosed is a system that may make it easier for golfers to connect with other golfers by using geolocation features to find available golfers with similar interests in playing style (through the profile setup and inputting golf interests and styles). The system may help the golfers book available tee times through the golf course of their choosing in their geolocation, and for golfers to use the disclosed system to score their games, calculate handicap, play the golf course with GPS mapping, find and locate their balls faster with the system, and for the golfers to improve their game with Al technology and Game Coaching features.

In one aspect, disclosed is a system for managing activities at a golf course, the system comprising a processor and a memory, the system configured to implement a method comprising determining a plurality of users in a specific geolocation that are available for a game of golf at a specific date and time and available tee times suitable to the plurality of users; generating user profiles, wherein the user profiles comprise interests and playing styles of respective users; tracking a golf ball during the game of golf using GPS data received from the golf ball, in near time, to trace a path taken by the golf ball; receiving, through an interface, for a service provider, orders for food and beverages from a user of the plurality of users at a golf course while engaged in the game of golf, wherein the service provider is determined based on the geolocation of the user; and scoring the game of golf, through the interface rendered on a user device. The method further comprises determining users with similar playing styles and interests based on their user profiles for pairing up users for the game. The method further comprises sending push notifications to the users about the golf course's tee-time bookings, memberships, tournament play, clubhouse news, upcoming events, pro-shop purchases, and food and beverage orders. The method further comprises determining users for a tournament based on the user profiles; and scoring the tournament, wherein scores are presented to each user through the user interface. The method further comprises receiving GPS mapping for scoring a golfer's game and calculating a handicap score at the end of play. The method further comprises creating custom formats or hybrid games by combining elements of different formats. The method further comprises rendering a booking screen on the user device, wherein an upper frame of the booking screen is configured to show available dates and time slots for tee time booking, and a lower frame shows a payment interface for selected date and time slot. Also, the booking screen shows available dates and time slots for all golf courses with their geolocations on a map-like screen on the interface. Thus, a golfer can easily access all the golf courses in an area with their locations on a map-like screen. Each golf course can be presented as an icon or badge on a map screen, wherein the user can click the icon to learn more about the associated golf course.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 shows a dashboard or a home screen of the interface, according to an exemplary embodiment of the present invention.

FIG. 4 shows a feedback screen of the interface which shows the golfer taking a shot and a comment by the system, according to an exemplary embodiment of the present invention.

FIG. 5 shows a scoring screen of the interface, according to an exemplary embodiment of the present invention.

FIG. 6 shows a menu screen of the interface, according to an exemplary embodiment of the present invention.

FIG. 7 shows a shot tracer screen of the interface, according to an exemplary embodiment of the present invention.

FIG. 8 shows a login screen of the interface, according to an exemplary embodiment of the present invention.

FIG. 9 shows a course search screen of the interface, according to an exemplary embodiment of the present invention.

FIG. 10 shows a booking screen of the interface, according to an exemplary embodiment of the present invention.

FIG. 11 shows a play screen of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The invention described pertains to a system and method for managing various activities at a golf course. The various activities may be directly or indirectly related to the game of golf, and include recreational activities, booking activities, and game scoring activities. The invention described can be used both by golfers and golf clubs in day-to-day tasks. There are lots of golfers that travel or are in areas that have lots of golf courses. In such a situation, the system can assist the golfers in finding a golf partner for a particular date and time, and from a specific geolocation, to pair up with. The system can also find available tee times that meet their needs. Different golf courses can register with the disclosed system and the golf courses can be presented with their location on a dynamic map screen. A user can click on the different golf course Icons on the map screen and look at more information about the golf course, see available tee times, and book and pay for the tee times right through one interface rendered on the user device.

Also, golfers may be looking for other golfers who are members of a specific golf course to pair up with for a game or join a team for tournament play. The disclosed system may help golfers find other golfers that have similar golfing styles, golf interests, goals, and even a handicap that they want to pair up with, instead of getting stuck with an unknown golfer.

The disclosed system and method can make it easier for golf clubs to manage the golf course's tee-time bookings, memberships, tournament play, and more, by simply sending push notifications to their members. This includes clubhouse news, upcoming events, management of payments for tee-time bookings, tournaments, pro-shop purchases, and food and beverage orders.

Various activities related to the game include finding other golfers to play with. The system can use the interests and styles of a golfer to suggest connections with other golfers who may have similar interests and styles. Also, using geolocation features, the current location of golfers can be determined which allows a golfer to find other golfers to play with. The geolocation features may help golfers book available tee times through the golf course of their choosing in their geolocation. The system may also allow golfers to score their games, calculate their handicap, play the golf course using GPS mapping, find and locate their balls faster with the Shot Tracer feature, and improve their game with Al technology using the Game Coaching features.

The clubhouses can streamline golf management for the clubhouses. Such as booking tee times, tournament organization, tournament play, and payments for sign-up. With up-to-date scoring pushed to the golf course during the tournament, mapping of current players and their geolocations on the course during play, ability to place drink and food orders and payments, simplified end-of-tournament scoring and ranking with handicaps and calculating pops into the players or the team's scores. The ability for clubhouses to promote tournaments, promote building their memberships, clubhouse news, and sales and promotions with push notifications. The ability for members to join as members of the golf course and make payments for memberships, book and pay for tee times, sign up and pay for tournaments as a team, or join a team that is looking for golfers. The disclosed system may provide a single platform for golf clubs to manage different aspects of the game and recreational activities.

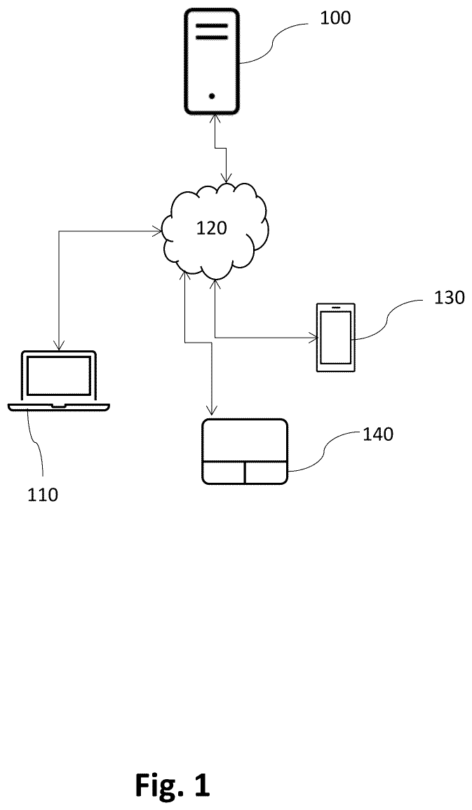

Now referring to FIG. 1 which is a block diagram showing an environment of the disclosed system 100. The system can connect to a service provider device 110 through a network 120. The service provider can be any service provider related to the game, such as golf clubs, recreation or relaxing service providers, game managers, and the like. While, for the purpose of illustration herein, FIG. 1 shows a single service provider connected to the system, it should be obvious to those reading this disclosure that the system can connect to multiple service providers at different locations, including different golf courses. The system can also connect to a member device 130 through the network 120. The members can be golfers registered with the disclosed system. The disclosed system can also connect to any game analytic device 140, such as a ball-tracking device.

The service provider and the member are also referred to herein as a user. The term “user” as used herein, and throughout this disclosure, refers to an individual engaging a user device to interact with the system. Similarly, the term user device encompasses service provider devices and member devices. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like.

The network 120 can be a communication network known in the art which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for the purpose of illustration herein, FIG. 1 shows a single network connecting multiple user devices, it should be obvious to those reading this disclosure that different user devices can connect with the system through various networks, and the same user device can connect with the system through more than one network. For example, a user device can connect to the system through a LAN and the Internet.

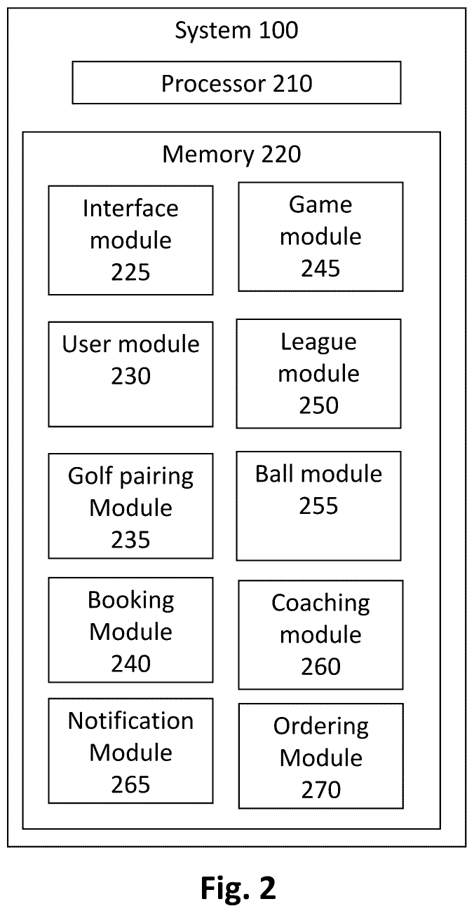

Referring to FIG. 2 is a block diagram showing the architecture of the system 100. System 100 includes a processor 210 and a memory 220 operably coupled to the processor 210. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The memory may include an interface module 225, which upon execution by the processor provides an interface on a user device to interact with the disclosed system. The memory may include a user module 230, which upon execution by the processor may allow registering a user and creating a profile for the user, wherein the profile may at least describe their style of play, golf interests, games and tournaments played, and goals.

The memory may include a golf pairing module 235, which upon execution by the processor may collect data from golfers including their profiles, locations, and the like. The data includes the geolocation of the golfers that may allow matching golfers for a game based on their current locations. The golf pairing module 235 can also pair the golfers based on the common golf courses they have enrolled themselves. The golf pairing module 235 can match the golfers based on their interests, goals, playing styles, and availability. This assists the golfers in finding golf partners to play with and the golfers can message each other to see if they want to play together and organize their golf outing.

The memory may also include a booking module 240, which upon execution by the processor allows the golfers to see available tee-times and different golf courses. The user can filter the tee times and golf courses based on geolocation, availability, and many other factors. The booking module 240 may allow the user to book and pay for the tee times and golf cart rental.

The memory may also include a game module 245, which upon execution by the processor allows GPS mapping of all golf courses, as well as scoring the game and calculating handicap at the end of play. The golfers may be able to see their scores for each golf course they have played as well as see their overall scores for all play.

The memory may also include a league module 250, which upon execution by the processor allows the promoters to recruit players for golf tournaments, manage tournament scoring for teams or individuals by being able to calculate the scores, handicap, and pops if needed, and post the scores for the tournament to the clubhouse news.

The memory may also include a ball module 255, which upon execution by the processor allows the player to find and locate the ball efficiently and speed up gameplay. The ball module may also enable tracing the path of a ball, referred to herein as shot tracing. The ball module 255 may use GPS or similar geo-positioning circuitry in a golf ball to trace the path of the ball.

The memory may also include a coaching module 260, which upon execution by the processor allows a player to capture their golf swing using a camera and use it to help improve their swing and their golf game.

The memory may also include a notification module 265, which upon execution by the processor allows for posting news and push notifications. The golf clubhouses can post upcoming events and information to members and non-members. The golfers can click on different golf courses in geolocation and look at the clubhouse news and forthcoming events. A lot of times golf courses are booked for an upcoming tournament/event and do not allow booking of tee times. Instead of calling the golf course to find out, a person can see if there is an upcoming tournament/event, and they will not be able to golf. Sometimes the golf courses may have discounted play specials on certain days of the week or may have ladies' nights or couples' nights to promote golf. This way members and non-members can join these events.

The memory may also include an ordering module 270, which upon execution by the processor allows ordering food and beverages. Sometimes players are in a hurry but want to order drinks and snacks at the turn or after golfing. The clubhouse can have its menu available for order and payment, so golfers can grab food and beverages when they want to. This may increase the speed and efficiency of play and will increase orders after play if players do not have time to sit and order in the clubhouse after play.

The system can be implemented in the form of servers, which include cloud servers. The servers can be placed in one location or geographically dispersed. Also, one or more steps of the disclosed methodology can be performed on one or more user devices without departing from the spirit of the disclosed subject matter. Also, one or more modules according to the present invention can be implemented by the user device without departing from the scope of the present invention.

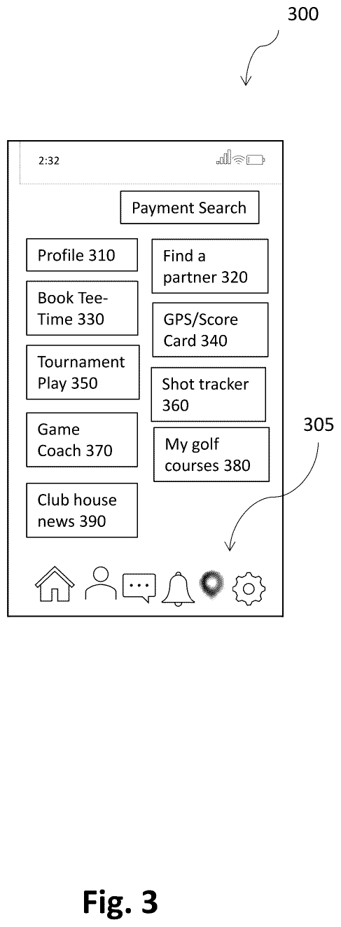

The interface provided by the interface module allows a user to interact with the disclosed system through a user device. The interface may include a series of screens, as shown in FIGS. 3-11, which in continuation can provide information as well as receive information from the user and execute one or more steps of the disclosed methodology. The interface can be dynamic and allows switching between sections, screens, pages, and the like quickly and easily. The interface can be provided as application software that can be installed on a user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The system allows golfers to be in touch with the golf courses and other golfers and enables golf courses to work seamlessly with other golf courses. The user module may allow an individual or a service provider willing to use the disclosed system to register themselves. The user module can receive basic information about the user, such as name, contact details, email address, and the like. Different kinds of information can be obtained from the golfers and the service providers. For example, from the golfers, information related to their interests and golf style can be obtained. From the service providers, a list of services with their descriptions can be obtained. Information can be obtained in the form of texts and images. For example, the image of the golfer or images of the service provider's place, and the like can be obtained.

The user module can generate a profile for each user to store all the information in an organized manner. The profiles can be stored in a suitable database by the system for retrieval and querying. The databases, including their structure and functioning, are known in the art. Also, the use of blockchain databases is well known. The present invention can use any suitable database without departing from the scope of the present invention. Also, the profile created by the user module can be later modified by the user. For example, FIG. 3 shows a dashboard screen 300 having a navigation bar 305. The navigation bar may include different icons to quickly switch between different screens. The dashboard screen includes a profile block 310. Selecting the profile block opens up another screen that may present the profile to the user. The user has the option to edit entries or add more information, and the user module can update the respective profile in the database. Information from the profiles can be used to create public profiles. The public profiles can be displayed to other users of the system. For example, the public profile of a service provider can be visible to the golfers. A public profile of a golfer can be visible to another golfer. A user may have control over his public profile, such as what information can be included in the public profile and who can view their public profile.

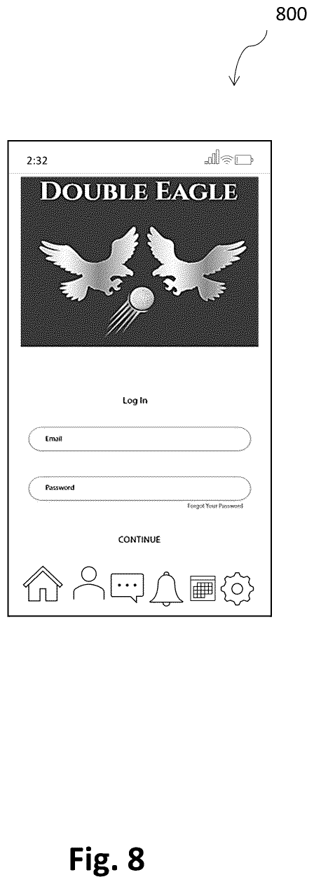

The golf pairing module allows golfers to connect, for example for a game. The golf pairing module can obtain profile information and geolocation of the golfers. The golf pairing module can use information from the profile, such as the age of the golfer, experience, game style, interests, and the like. The golf pairing module then uses this information with geolocation to suggest connections to a golfer. The golfers can pair up to schedule a game. A golfer can also instantly find golf partners to play with. The golf pairing module can match the golfers that have the same interests, goals, styles, and availability together. This may assist the golfers in finding golf partners to play with, and the golfers can message each other to see if they want to play together and then easily organize their golf outings. Now referring to FIG. 3 which is a dashboard screen of the interface that may be presented to the user upon login into the system. The dashboard screen has a block 320 “find my partner”. Clicking on block 320 may open another screen that may allow the golfer to find a partner. FIG. 8 shows a login screen 800 that may be rendered on the user device for secure access.

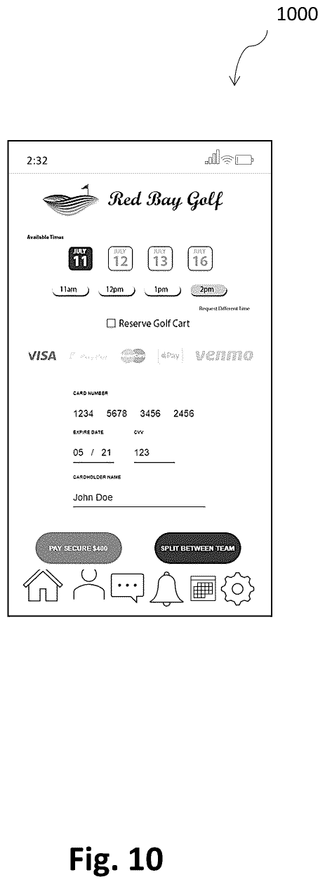

The booking module may allow the golfers to book tee times. Golfers can see available tee times and different golf courses in their geolocation and book and pay for the tee times and golf cart rentals. Again, referring to FIG. 3, block 330 may be used to book the tee time, wherein selecting block 330 may open another screen for booking. FIG. 10 shows a booking screen 1000 showing the day and time slots available. The user can select the desired time slot and pay for the same using the payment screen. The disclosed system is particularly useful in that the golfers can find all available golf courses in a geolocation that are listed on the disclosed system. The golfer can manage various aspects of the golf game including learning, practicing, tournaments, and the like from a single interface. The golfers need to create an account to see all/many golf courses in that geolocation and access their golf course information, book tee times, manage payments, etc. Different golf courses from different organizations can be accessed through a single user account according to the present invention.

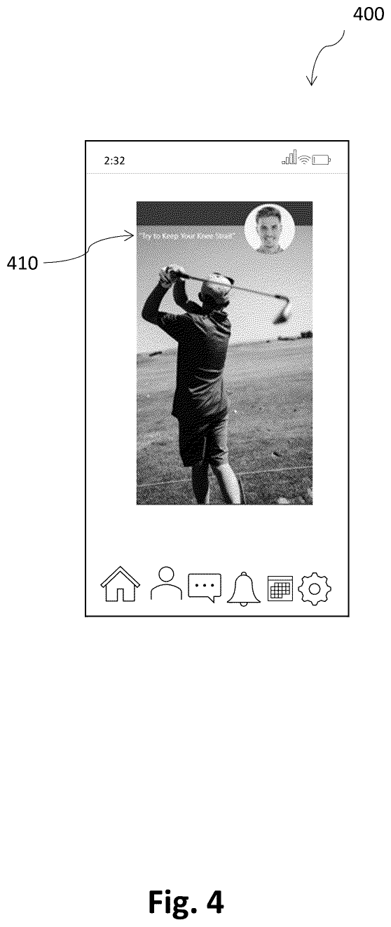

The game module may allow for scoring the game and may provide game analytics in near real-time. For analytics, the game module may use data from recorded games to train Al models. The game module may use cameras and position sensors to detect movements and body postures. For example, a sensor may be coupled to a wrist and putter to detect movement. FIG. 4 shows a feedback screen 400 illustrating a shot taken by a player. The feedback screen shows the image of the player and a comment 410 on the flaw in taking the shot by the player.

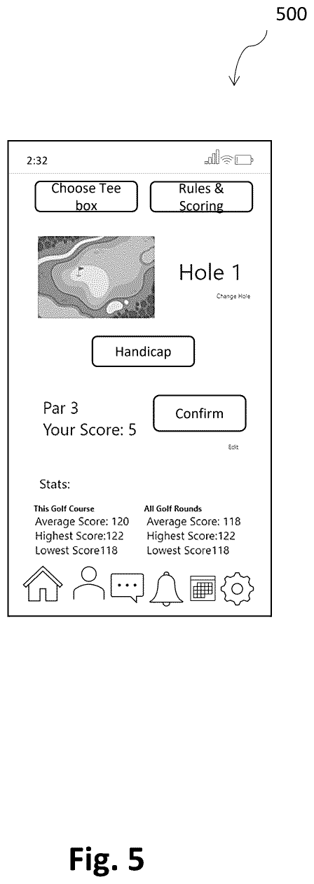

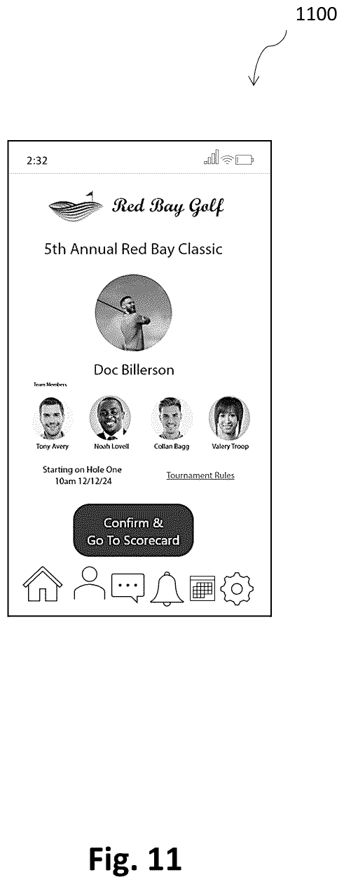

The game module can receive GPS mapping for scoring a golfer's game and calculating the handicap score at the end of play. The golfer may be able to see their scores for each golf course they have played in as well as see their overall scores for all the times that they have played. FIG. 3 shows the block 340 on the dashboard screen 300 which can be used to access the scores. The game module may also be used to manage and track scores in tournaments. FIG. 11 shows a play screen 1100 of a tournament in which a golfer can see the members and can also check the scorecard. FIG. 5 shows another scoring screen 500 for the handicap score.

In certain implementations, the interface may allow scoring in which the tournament participants may input scores hole-by-hole with instant leaderboard updates. Also, the system may allow for handicap integration, wherein the system may automatically adjust the scores based on players' handicaps. Multiple players may be added for the scoring functionality, for example, four players per group may be added, with options to score additional groups for large tournaments. For tournaments with teams (like a scramble or shamble), the game module may allow calculating the team's score based on the format's rules.

The game module may also support league play wherein the users may manage their league's standings over multiple rounds. Each player's scores are tracked cumulatively, and the game module can rank players or teams based on total scores, points, or other criteria set by the league. For League Setup, the Admins can configure the season length, number of players, and format (stroke play, match play, etc.). For Live Standings, the game module may show current standings in the league based on real-time input, including tie-breaking criteria like lowest handicap or best round.

The game module may also support individual play by supporting casual, round-based scorekeeping. Players can track personal progress, and view detailed statistics on fairways hit, greens in regulation (GIR), putts per round, and more. For Stat Tracking, In-depth statistics on strokes per hole, average drive distance, putting accuracy, and penalties. For goal setting, it allows players to set performance goals and track progress over time.

The game module may support format rules and scorekeeping for a wide variety of popular and less common golf formats, enhancing flexibility for users who want to play various types of games:

### Stroke Play (Medal Play)

Rules: Each player or team records the total number of strokes taken per hole, and the player with the lowest overall stroke count wins. In team events, scores can be aggregated.

Scoring: The app will tally strokes per hole, providing cumulative totals, including gross and net scores (handicap-adjusted).

### Match Play

Rules: Players or teams compete hole by hole. The player or team with the lowest score on a hole wins that hole. The match is won by the player/team that wins the most holes.

Scoring: The app tracks the number of holes won, lost, and halved, offering dynamic match status updates like “1 Up” or “All Square.”

### Scramble

Rules: In a scramble, all team members hit a tee shot. The best shot is selected, and all players hit from that position. This continues until the hole is completed. Teams record the number of strokes it took to finish the hole.

Scoring: The app calculates the team score based on the best-selected shots, allowing for easy input of team totals for each hole.

### Shamble

Rules: All players tee off, and the team selects the best drive. Each player then plays their own ball from that position until the hole is completed. The team's score is often the best 1-2 balls of the group.

Scoring: The app supports individual stroke tracking after the best drive is selected and provides options for scoring based on the format (e.g., best individual score or aggregate score for the team).

### Stableford

Rules: In Stableford, players earn points based on the number of strokes relative to par on each hole (e.g., 1 point for par, 2 for birdie, etc.). The highest point total wins.

Scoring: The app will automatically calculate points based on the player's strokes on each hole, updating scores in real time.

### Best Ball

Rules: In best ball, each player plays their own ball throughout the round, and the best score among the team members for each hole is recorded.

Scoring: The app will track individual player scores and automatically determine the best score per hole for the team.

### Fourball

Rules: Similar to the best ball, two teams of two players, each compete against each other. The best score from each team on a hole is compared, and the lowest score wins the hole.

Scoring: The app provides hole-by-hole tracking and shows which team has won each hole.

### Foursomes (Alternate Shot)

Rules: Two players on each team take alternate shots with one ball per hole, switching who tees off on each hole.

Scoring: The app tracks each team's strokes per hole, tallying total strokes for the round.

### Skins Game

Rules: Each hole is worth a set number of points (or money), and the player with the lowest score on a hole wins the skin. If no one wins a hole outright, the skin carries over to the next hole.

Scoring: The app calculates skins per hole and tracks the carryover when applicable.

### Nassau

Rules: Nassau is essentially three matches in one: one match for the front nine, one for the back nine, and one for the overall 18 holes. Players or teams can win individual matches or all three.

Scoring: The app tracks match results for each segment of the round.

### Ryder Cup Format

Rules: Teams play a combination of formats (such as foursomes, fourballs, and singles matches) across multiple rounds or days. The team with the most match wins takes the overall victory.

Scoring: The app provides integrated tracking for all formats played in a Ryder Cup-style event and displays team points.

### Vegas

Rules: Vegas is a team-based betting game played by pairs. The scores of the two players on each team are combined, but instead of adding them together, the numbers are concatenated to form a new number. For example, if Player A scores a 4 and Player B scores a 3, the team's score for that hole is 43. The team with the lower “Vegas” score wins the hole.

Twist: If a player scores a birdie (or better), the scores are reversed, putting the lower number in front. For instance, if Player A scores a 4 and Player B scores a 2, the score would normally be 42, but with a birdie, it becomes 24.

Scoring: The app will calculate the concatenated team scores for each hole and track which team has the lowest Vegas score for the round. Penalties and bonuses for birdies can be integrated automatically.

### Rabbit

Rules: In Rabbit, players compete to “capture the rabbit” by having the lowest score on a hole. The game is divided into three sections: the first six holes, the next six, and the final six. The objective is to hold the rabbit (the best score) for as many holes as possible in each segment.

Capturing the Rabbit: A player must have the lowest score on a hole to “capture” the rabbit. Once captured, the player must continue to have the lowest score to retain the rabbit.

Losing the Rabbit: If another player scores lower than the rabbit holder on a hole, the rabbit is “released,” and the next low-scorer captures it.

Scoring: The app tracks which player captures the rabbit, how long they hold it, and resets the game at each six-hole segment.

### Six-Six-Six (or Rotation)

Rules: Six-Six-Six, also known as “Rotation,” is a team game where teams change every six holes. Players compete in a different format for each of the three sets of six holes (e.g., first six holes as best ball, next six as alternate shot, and final six as scramble). Team Rotation: Players are partnered with each other player in the group for six holes each. Format Rotation: The game format for each six-hole segment can change, such as the best ball for the first six holes, an alternate shot for the next six, and a scramble for the last six holes.

Scoring: The app will support different scoring formats (best ball, alternate shot, scramble) for each six-hole section and automatically update team scores based on the chosen format for each segment.

### Wolf

Rules: Wolf is a strategic game where one player is designated as the “Wolf” on each hole, and that role rotates among the players. The Wolf tees off first and must decide whether to play alone (as the “Lone Wolf”) or to partner with another player after they hit their tee shot.

The Lone Wolf: If the Wolf chooses to go solo, they can earn double the points for the hole if they win but will lose double if they don't.

Partnering: The Wolf can select a partner after seeing each player's tee shot. If the Wolf's team wins, they earn points, but if they lose, the opposing players earn the points.

Scoring: Points are awarded based on how many players were involved in the winning team (the Wolf solo or with a partner).

Scoring: The app tracks points earned by each player based on whether they were the Wolf, partnered up, or went alone. The scoring varies based on the outcome of each hole and the player's role.

### Bingo, Bango, Bongo

Rules: This points-based game rewards players for three specific accomplishments on each hole:
Bingo: The first player to reach the green earns a point.
Bango: The player whose ball is closest to the pin once all balls are on the green earns a point.
Bongo: The first player to sink their putt earns a point.

This format equalizes players of different skill levels because the points are based on specific achievements, not just the scores.

Scoring: The app tracks who earns Bingo, Bango, and Bongo on each hole and totals points over the round. It can also show leaderboards for which players are ahead based on points earned.

The game module may also allow for Advanced Scoring Features including customizable formats, score adjustments, handicap management, GPS, and club selection integration. The game module may allow the tournament or league organizers to create custom formats or hybrid games by combining elements of different formats (e.g., front-nine scramble and back-nine best ball). The scores can be manually adjusted for penalty strokes, mulligans, pops, or special tournament rules. Also, the game module may automatically adjust scoring for players' handicaps, showing both gross and net scores. The game module may also integrate GPS for accurate shot distance measurements and offer club recommendations based on performance data from previous rounds.

The league module may allow promoting and recruiting players for golf tournaments, league play, managing tournament/league scoring for teams or individuals by being able to calculate the scores handicap, type of game played, and pops, if need be, and post the scores for the tournament/league to the clubhouse news and the tournament/league players. FIG. 3 shows a block 350 for tournament play that may open screen 1100 shown in FIG. 11.

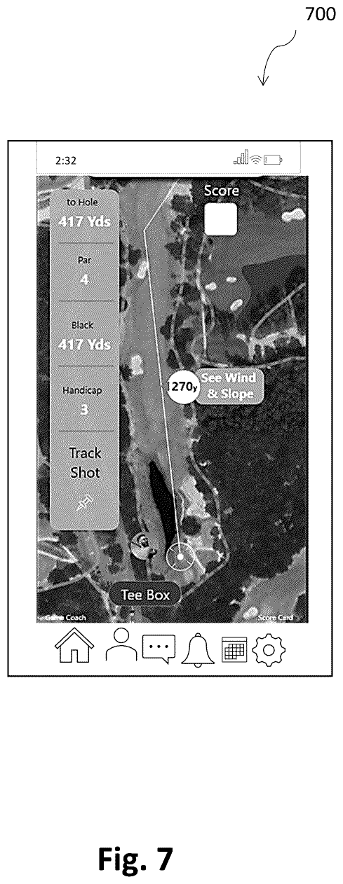

The ball module may allow players to locate the ball while playing. The system may show the precise location of the ball, thus making it easier for the players to locate the ball in the game. The ball may include a suitable positioning system to determine and broadcast in the near real location of the ball. For example, the positioning system may be a GPS circuitry or the like, and such a positioning system may be incorporated without departing from the scope of the present invention. The system may also allow tracing a path of the bath, thus making the game more exciting. The shot tracer module may receive the map of the course and the GPS mapping to show the ball route. FIG. 3 shows a block 360 as one of the menu items that may be selected by the user for shot tracing. FIG. 7 shows the shot tracing 700 which may show all the details including the path of the ball, distance, and score.

The coaching module may provide access to a range of videos and tutorials for the golfers to learn. The coaching module may provide curated training material to the player based on the player's style and performance. The coaching module may also receive the performance or game action of the player using one or more cameras. The coaching module using artificial intelligence and image recognition algorithms can evaluate the performance and shortcomings, and accordingly, suggest corrections to the user. In certain implementations, suitable sensors, such as a gyroscope and accelerometer, can be installed on the golf putter. Similar sensors can be placed on the gloves of the golfer. Using these sensors, the movement of the hand and the putter can be modeled by the system.

The notification module may allow the posting of news and notifications to the golfer. A notification screen can be implemented by the interface module that allows displaying notifications to the golfer. The notifications include push notifications that can be presented as a pop-up on the screen. FIG. 3 shows block 390 which may be used to access news of preselected club houses.

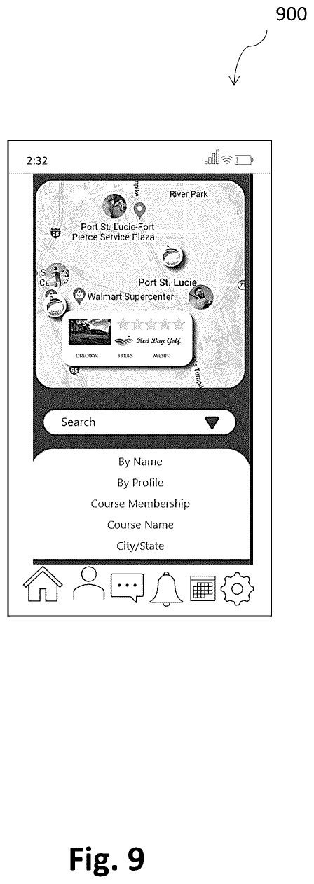

Through notification modules, the system can post any upcoming events and information to members as well as non-members. Golfers can click on different golf courses in a geolocation of their choosing and look at the clubhouse news and upcoming events. A lot of times golf courses are booked for an upcoming tournament, league, or event and do not allow booking of tee times. Instead of calling the golf course to find out, users will be able to see that there is an upcoming tournament, league, or event and know they are not able to golf during that time. Additionally, golf courses may have discounted play specials on certain days of the week or may have a ladies' night or couples' night to promote golf. The system allows members and non-members alike to see when these events are happening and join in if they would like. FIG. 9 shows a screen 900 that may allow a user to search for any courses.

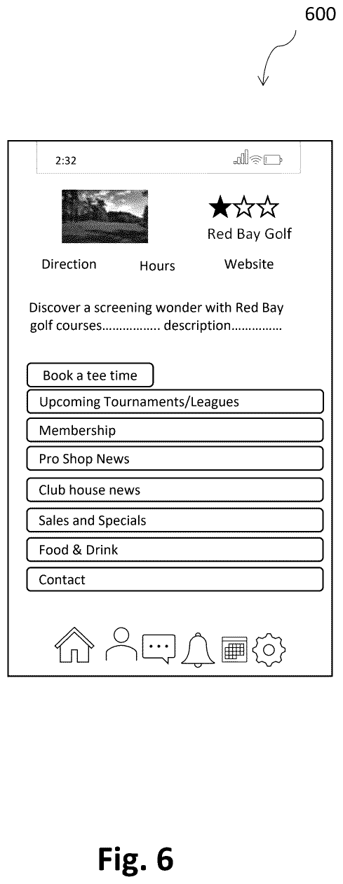

The ordering module may allow for ordering the food and beverage items by the users. The ordering module can automatically determine the current location of the user and display available food and beverage services nearby. The user can view available items through an interface provided by the system on their user devices. The user can also order the items and make payments through their mobile devices. Sometimes players are in a hurry but would like to order drinks and snacks at the turn or when they are done golfing. The system may make it easy for the clubhouse to have its menu available for order and payment so that golfers can grab food and beverages when they want to. Again, this will increase the speed and efficiency of play, and it will also increase orders after play if players do not have time to sit and order in the clubhouse after play. FIG. 6 shows a menu screen 600 that may have different options for the user. The user can discover news, manage memberships, and shop, using the menu screen 600. The menu screen 600 also has the option of booking food and beverages.

The disclosed system through the interface can provide a range of features and will help everyone make the golf process much easier and more enjoyable. The disclosed system can provide personalized services to the user based on their age, likes, and dislikes. Clubhouses, whether new or old, can automate the ordering process and improve customer experience.

The disclosed system can be particularly useful for new golfers to find partner golfers to start playing. Also, a lot of golfers travel and/or are in an area that has many golf courses. In such a case, the system may assist golfers who want to find a golf partner for a specific date, time, and geolocation to easily pair up with other golfer(s) and find available tee times that meet their needs. Or maybe golfers want to find other golfers who are members of a specific golf course to pair up with and golf or join a team for league and/or tournament play. The goal of the invention is to help golfers find other golfers that have similar golfing styles, golf interests, and goals—even a handicap that they want to pair up with—instead of getting stuck with a stranger to golf with.

Another important feature of the invention is to streamline golf management for the clubhouses. Features include booking tee-times, tournament/league organization and play, and determining the type of rules for tournament/league play—including the ability to input popular tournament/league rules for each hole or for their particular tournament/league, such as a Scramble, Gross or Net Stroke Play, Match Play, Best Ball, Shamble, and more—and easy payment avenues for player sign up are just the beginning. With up-to-date scoring pushed to the golf course during tournament/league play, mapping of current players and their geolocations on the course during play, the ability for players to place drink and food orders and payments, simplified end-of-tournament/league scoring and ranking with handicaps and calculating pops into the players or the teams scores will make every day and tournament/league play easier for clubhouses to manage and ensures that the golfers are happy. Clubhouses will be able to promote tournaments and leagues, build their memberships, share clubhouse news, and boost sales and promotions with push notifications. Through invention, users will have the ability to join as a member of the golf course, make payments for memberships, book and pay for tee times, and sign up and pay for tournaments/leagues as a team or join a team that is looking for golfers.

This system will enhance golfer-to-golfer interactions, golf course to golf course connections and collaborations, and the golfer and golf course connectivity. It will also improve golfers' all-around games with multiple different game improvement features. The system combines all the features that are used in other apps and includes additional features not yet available in the system that will make life simpler for both golfers and the clubhouses. No longer will golfers have to create multiple logins for different golf courses or call the clubhouse to find tee-time availability, book and pay for a tee time, and reserve a golf cart rental. This invention is a win-win for golfers and clubhouses alike—it will make the golfing experience easier and more enjoyable.

The system may allow the golfers to find members and non-members of golf courses they want to play at. For example, a golfer wants to pair with a golf member who knows the course, or maybe they want to try a course out with a non-member who has a similar golf interest and style.

The system gives golfers the ability to meet their particular needs, interests, and playing style (ready golf, drink and socialize, play same tee-boxes, and so forth). Once golfers create a profile, the system can help match up golfers with similar interests and styles, as well as golfers looking for other golfers who are available to golf on certain dates and times. After the system connects the golfers, the golf partners can find golf courses in their geolocation, look at available tee times that work for their schedules, and then book and pay for the tee time right through the interface provided by the system.

The system can enable golfers to manage and improve their games through rules of play and scoring for popular golf games including Best Ball, Alternate Shot, Vegas, Bingo, Bango, Bongo, and regular golf scoring, handicap calculations, GPS map for golf courses, Shot Tracer (ball finder), Game Coach (AI), and makes it easy for them to pair up to play a course.

The system can make it easy for clubhouses to streamline and manage the golf course and connect with other golf courses, manage bookings and payments for tee-times, golf cart ordering, organize team/individual sign-up for golf tournaments and league play, organize the tournament/league play, indicate the type of rules used in the tournament/league, score with handicaps/pops, manage their golf members submitting scores and calculating handicaps to the clubhouse, and enroll new members while managing their current memberships.

The system eliminates the need to have multiple devices for managing the game. The system makes it easier for clubhouses and golfers to connect, whether they are members or not. The goal is also for clubhouses to connect and interact with other golf courses. For example, a golfer is a member of XYZ golf course, and they get to play half off or at a discounted rate at different golf courses due to their golf membership. Lots of golf courses do that to promote golfers trying out other courses to increase non-member bookings and promote memberships. When golf courses are interconnected with each other in this system, the golfers will be able to see other golf course specials and the golfer can then book a tee time with the golf course without having to go through the members' golf course to learn about the specials and to book the tee time. This will assist the golfer in managing the bookings and collaborating with other courses to promote memberships and golfing in general.

The disclosed system can bring together all the golf courses and make them accessible through a single interface. A user does not have to bear the pain of signing up with different golf courses. A single account and user profile may allow access to the majority of the golf courses. The system allows users to check for tee-times, news, updates, and the like. The user can see and avail the different services provided at the golf courses right from his smartphone and from anywhere.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for managing activities at a golf course, the system comprising a processor and a memory, the system configured to implement a method comprising:
determining a plurality of users in a specific geolocation that are available for a game of golf at a specific date and time and available tee times suitable to the plurality of users;
generating user profiles, wherein the user profiles comprise interests and playing styles of respective users;
tracking a golf ball during the game of golf using GPS data received from the golf ball, in near time, to trace a path taken by the golf ball;
receiving, through an interface, for a service provider, orders for food and beverages from a user of the plurality of users at a golf course while engaged in the game of golf, wherein the service provider is determined based on a geolocation of the user; and
scoring the game of golf, through the interface rendered on a user device.

2. The system of claim 1 wherein the method further comprises:
determining users with similar playing styles and interests based on their user profiles for pairing up users for the game.

3. The system of claim 1, wherein the method further comprises:
sending push notifications to the users about golf course's tee-time bookings, memberships, tournament play, clubhouse news, upcoming events, pro-shop purchases, and food and beverage orders.

4. The system of claim 1, wherein the method further comprises:
determining users for a tournament based on the user profiles; and
scoring the tournament, wherein scores are presented to each user through a user interface.

5. The system of claim 1, wherein the method further comprises:
receive GPS mapping for scoring a golfer's game and calculating a handicap score at an end of play.

6. The system of claim 1, wherein the method further comprises:
creating custom formats or hybrid games by combining elements of different formats.

7. The system of claim 1, wherein the method further comprises:
rendering a booking screen on the user device, wherein an upper frame of the booking screen is configured to show available dates and time slots for tee time booking, and a lower frame shows a payment interface for selected date and time slot.

8. A method for managing activities at a golf course, the method implemented within a system comprising a processor and a memory, the method comprising:
determining a plurality of users in a specific geolocation that are available for a game of golf at a specific date and time and available tee times suitable to the plurality of users;
generating user profiles, wherein the user profiles comprise interests and playing styles of respective users;
tracking a golf ball during the game of golf using GPS data received from the golf ball, in near time, to trace a path taken by the golf ball;
receiving, through an interface, for a service provider, orders for food and beverages from a user of the plurality of users at a golf course while engaged in the game of golf, wherein the service provider is determined based on a geolocation of the user; and
scoring the game of golf, through the interface rendered on a user device.

9. The method of claim 8 wherein the method further comprises:
determining users with similar playing styles and interests based on their user profiles for pairing up users for the game.

10. The method of claim 8, wherein the method further comprises:
sending push notifications to the users about golf course's tee-time bookings, memberships, tournament play, clubhouse news, upcoming events, pro-shop purchases, and food and beverage orders.

11. The method of claim 8, wherein the method further comprises:
determining users for a tournament based on the user profiles; and
scoring the tournament, wherein scores are presented to each user through a user interface.

12. The method of claim 8, wherein the method further comprises:
receive GPS mapping for scoring a golfer's game and calculating a handicap score at an end of play.

13. The method of claim 8, wherein the method further comprises:
creating custom formats or hybrid games by combining elements of different formats.

14. The method of claim 8, wherein the method further comprises:
rendering a booking screen on the user device, wherein an upper frame of the booking screen is configured to show available dates and time slots for tee time booking, and a lower frame shows a payment interface for selected date and time slot.
